(19) United States
(12) Patent Application Publication
(10) Pub. No.: US 2022/0291959 A1
(43) Pub. Date: Sep. 15, 2022

(54) Activity scheduling method, system, terminal and storage medium based on high response ratio

(71) Applicant: RESEARCH INSTITUTE OF PHYSICAL AND CHEMICAL ENGINEERING OF NUCLEAR INDUSTRY, Tianjin (CN)

(72) Inventors: Yue Wang, Tianjin (CN); Yang Chen, Tianjin (CN); Liangxu Zhang, Tianjin (CN); Zhe Chen, Tianjin (CN); Bing Li, Tianjin (CN); Duo Chen, Tianjin (CN); Ye Li, Tianjin (CN); Chunhua Lu, Tianjin (CN)

(21) Appl. No.: 17/829,186

(22) Filed: May 31, 2022

(30) Foreign Application Priority Data
Jun. 3, 2021 (CN) 202110618087.9

(51) Int. Cl. G06F 9/48; G06F 9/50

(52) U.S. Cl. CPC G06F 9/4881; G06F 9/5038; G06F 9/4818

(57) ABSTRACT

An activity scheduling method based on a high response ratio includes steps of: setting basic software and hardware information, an activity queue, a user authority, and a user weight factor through an administrator terminal; wherein the user weight factor comprises: a user weight factor dynamic value, a user weight factor quantity value, and a user weight factor cooling time; manually choosing whether to adopt the user weight factor for an activity through a user terminal, and then submitting the activity; and entering an activity queuing stage of the user terminal, determining an activity priority of the user terminal according to a scheduling method, and running the activity in a descending order of the activity priority. The activity scheduling method allows the system to determine and run the current urgent and important activities without manual intervention in software and hardware resources.

### CROSS REFERENCE OF RELATED APPLICATION

The present invention claims priority under 35 U.S.C. 119(a-d) to CN 202110618087.9, filed Jun. 3, 2021.

### BACKGROUND OF THE PRESENT INVENTION

### Field of Invention

The present invention relates to a technical field of computer applications, and more particularly to an activity scheduling method, system, terminal and storage medium based on a high response ratio.

### Description of Related Arts

In the conventional high-performance computing cluster environment, there are always some tasks that need to be run preferentially. According to conventional sorting method, fairness is taken into account to a certain extent, but the priority of user activities cannot be reflected. The conventional adjustment method can only manually intervene in the activity priority by the administrator, which is inefficient and labor-intensive.

The main process of the conventional high response ratio priority scheduling algorithm in activity scheduling is as follows.

In order to simplify the description process, the minimum resource usage unit of a high-performance computer is defined as a computer node, rather than several CPU computing cores in one node. The practical scenario can be extended to multiple computers.

M is a set of all unscheduled activities, and H is a set of all computer nodes:

(1) determine whether the activity set M is empty, if not, go to step (2); otherwise, skip to step (6);

(2) for all tasks in the activity set, calculate their cumulative waiting time and estimated running time to obtain a response ratio, i.e. response ratio=(waiting time+estimated running time)/estimated running time=1+(waiting time/estimated runtime);

(3) according to the result of step (2), find out the activity mi with the highest response ratio and the corresponding machine hj;

(4) send the task mi to the machine hj for running; and delete the task from the task set;

(5) mark the machine hj as occupied, and update the status of all machines; and

(6) receive a new activity and put it into the set M, and go back to step (1).

According to the formula, it can be known that:

When the waiting time of the activity is constant, the shorter the required service time, the higher the response ratio, which is beneficial to short activities.

When the required running time is constant, the response ratio of the activity is determined by its waiting time, the longer the waiting time, the higher the response ratio, so it executes a first-come-first-run operation.

For long activities, the response ratio of the activity can increase as the waiting time increases. When the waiting time is long enough, the response ratio can be very high, so that the processing opportunity can also be increased. The starvation state is overcome and the long activity is taken into account.

In summary, the problems in the prior art are as follows:

The conventional high response ratio priority scheduling algorithm adopts three principles: short activities are preferred, those first come are first served, and long activities can obtain processing opportunities by increasing the waiting time. However, the response ratio computing system costs more. In addition, according to this sorting method, fairness is taken into account to a certain extent, but the priority of user activities cannot be reflected since the processing opportunities are obtained by increasing the waiting time. When urgent tasks need to be run first, the user can only manually intervene in the activity priority, resulting in low efficiency and affecting activity processing efficiency.

The difficulty of solving the above-mentioned technical problems lies in how to let the system determine and run the current urgent and important activities without manual intervention in software and hardware resources, thereby satisfying the urgent needs of scientific research progress as well as model research and development.

The significance of solving the above-mentioned technical problems is: the present invention schedules activities on the basis of the Highest Response Ratio Next algorithm (HRRN), and adds the attribute of the user weight factor, which includes the size of the user weight factor, the number of the user weight factor and the cooling time of the user weight factors, to dynamically adjust activity priority. Such algorithm is named as Dynamic User Factor Highest Response Ratio Next, i.e. DUF HRRN.

The algorithm can overcome the problem that user activities cannot fairly obtain computing resources due to fixed user weights when the system is running at full load, which increases the success rate of scheduling, improves the fairness of tasks, and prevents the high-weight users from excessively occupying computing resources, thereby controlling the activity priority.

### SUMMARY OF THE PRESENT INVENTION

To overcome defects in the prior art, an object of the present invention is to provide an activity scheduling method, system, terminal and storage medium based on a high response ratio.

Accordingly, in order to accomplish the above object, the present invention provides:

an activity scheduling method based on a high response ratio, comprising steps of:

101: setting basic software and hardware information, an activity queue, a user authority, and a user weight factor through an administrator terminal;

wherein the user weight factor comprises: a user weight factor dynamic value, a user weight factor quantity value, and a user weight factor cooling time;

102: manually choosing whether to adopt the user weight factor for an activity through a user terminal, and then submitting the activity;

wherein:

choosing Yes, the activity adopts the user weight factor dynamic value set in the step 101, and is not 1; or

choosing No, the user weight factor dynamic value of the activity is 1 by default; and

103: entering an activity queuing stage of the user terminal, determining an activity priority of the user terminal according to a scheduling method, and running the activity in a descending order of the activity priority.

Preferably, the scheduling method in the step 103 comprises steps of:

201: determining whether an activity set M is empty, if not, going to a step 202; otherwise, skipping to a step 206;

202: calculating a weighted response ratio of each activity in the activity set M;

wherein the weighted response ratio=[(waiting time+estimated running time)/estimated running time]*user weight factor dynamic value=[1+(waiting time/estimated running time)]*user weight factor dynamic value;

203: according to a result of the step 202, finding out an activity mi with a highest weighted response ratio and a corresponding machine hj thereof;

204: sending the activity mi to the machine hj for running, and deleting the activity mi from the activity set M;

205: marking the machine hj as occupied; and

206: updating statuses of all other activities; receiving a new activity and putting the new activity into the activity set M, and returning to the step 201;

wherein the activity set M is a set of all unscheduled activities.

Preferably, in the step 204, if the user weight factor dynamic value of the activity mi is not 1, when the activity mi is deleted from the activity set M, the user weight factor quantity value of the user terminal corresponding to the activity is synchronously decreased by 1;

Preferably, after the user weight factor dynamic value of the user terminal is reduced by 1, when the user weight factor cooling time of the activity mi expires in the step 206, the user weight factor dynamic value of the activity mi is returned to the user terminal, and the user weight factor quantity value of the user terminal is increased by 1.

Preferably, in the step 202, the weighted response ratio=[1+(waiting resource/estimated resource)]*user weight factor dynamic value.

Preferably, in the step 102, the system automatically assigns the user weight factor for the activities of the user terminal, and then submits the activity;

wherein:

when the user weight factor of the user terminal is larger than 0, the activity adopts the user weight factor dynamic value set in the step 101, and is not 1;

when the user weight factor of the user terminal is 0, the user weight factor dynamic value of the activity is 1 by default.

The present invention also provides an information data processing terminal to implement the activity scheduling method based on the high response ratio.

The present invention also provides a computer-readable storage medium having instructions stored thereon, wherein when the instructions are executed on a computer, the computer executes the steps of the activity scheduling method based on the high response ratio.

The present invention also provides a computer device, comprising a memory and a processor, wherein a computer program is stored in the memory, and the processor executes the computer program to execute the steps of the activity scheduling method based on the high response ratio.

The present invention also provides an activity scheduling method based on a priority, comprising applying the user weight factor as recited in claim 1, wherein a weighted priority=fp;

wherein fp is a new weighted priority obtained by calculating a priority in a current algorithm with the user weight factor dynamic value.

With the foregoing technical solutions, the present invention has the following advantages and effects:

1. It is the user that chooses whether to use the user weight factor, which means the user decides whether to handle the activity urgently. Based on the user decision, the system can manually use the user weight factor, automatically use the user weight factor, or not use the user weight factor. This scheduling method can greatly differentiate users and focus on key users.

2. The user weight factor quantity value is used to refine the control range of the user activity priority. The user weight factor will decrease after being used by the user or the system, and is not constant, so as to avoid lack of system resources.

3. The user weight factor cooling time is used to precisely control the reusable time of the user weight factor and prevent the repeated use of the user weight factor in a short time.

4. Different combinations are used for different users according to the activity situations. The user weight factor dynamic value, the user weight factor quantity value, and the user weight factor cooling time are combined instead of using a single user weight factor, which is convenient for diversified processing and comprehensive adjustment of the activity priority, and avoids blindly raising the priority of all activities for some users.

5. The above technical processing can comprehensively control the running order of the activities according to the user activity attributes and waiting time under the situation of tight system resources and serious activity competition, so as to control and optimize the activity priority.

6. In addition to being applied to users, the present invention can also be applied to activity types, so as to give different dynamic values, quantities and cooling times to different activity types, rather than use a single user weight factor to adjust activity priority. For example, 3 users can be switched to 3 kinds of software activities.

7. In addition to being applied to the priority scheduling algorithm based on the high response ratio, the present invention can also be applied to other similar conventional algorithms to further optimize the algorithm and system resources.

### BRIEF DESCRIPTION OF THE DRAWINGS

Technical solutions of the present invention will be further described below with reference to accompanying drawings and embodiments.

FIG. 1 is a flowchart of an activity scheduling method of the present invention when a user weight factor is manually set;

FIG. 2 is a flow chart of the activity scheduling method of the present invention when the user weight factor is set by a system; and

FIG. 3 is an overall flow chart of the activity scheduling method of the present invention.

### DETAILED DESCRIPTION OF THE PREFERRED EMBODIMENT

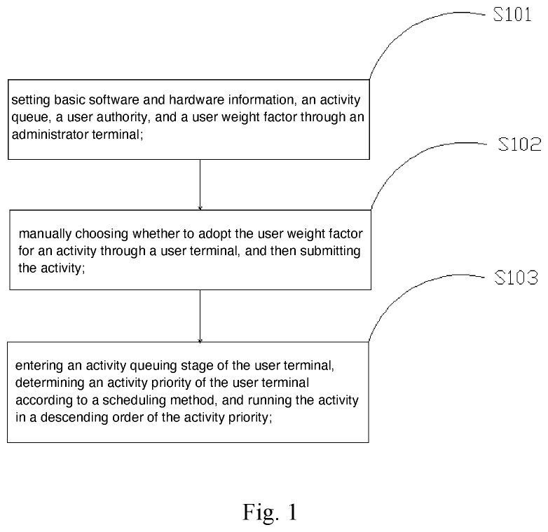

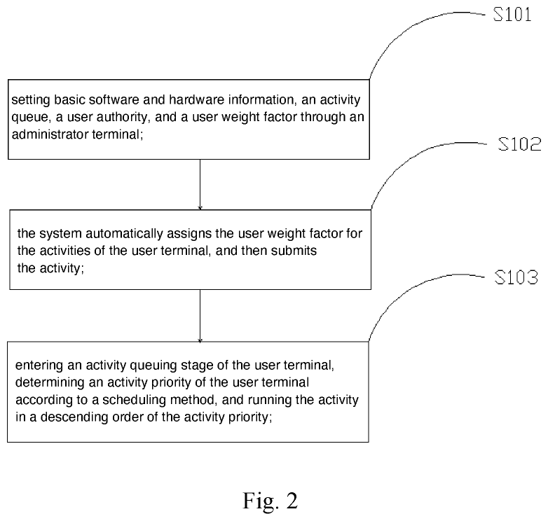

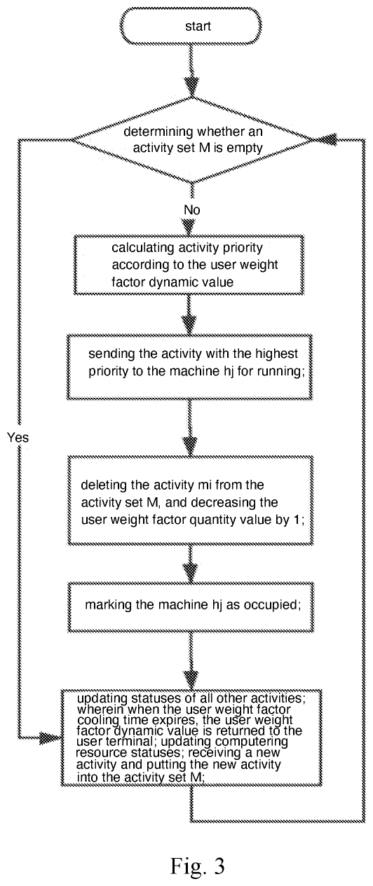

Referring to FIGS. 1-3 of the drawings, the present invention will be further illustrated.

### Embodiment 1

Referring to FIG. 1, the present invention provides an activity scheduling method based on a high response ratio, comprising steps of:

101: setting basic software and hardware information, an activity queue, a user authority, and a user weight factor through an administrator terminal;

wherein the user weight factor comprises: a user weight factor dynamic value, a user weight factor quantity value, and a user weight factor cooling time;

102: manually choosing whether to adopt the user weight factor for an activity through a user terminal, and then submitting the activity;

wherein the user terminal can also select and fill in necessary contents for activity running, such as activity solution files, running scripts, required software versions, and process parallelism (i.e. the number of CPU cores) and other optional parameters;

wherein:

choosing Yes, the activity adopts the user weight factor dynamic value set in the step 101, and is not 1; or

choosing No, the user weight factor dynamic value of the activity is 1 by default; and

103: entering an activity queuing stage of the user terminal, determining an activity priority of the user terminal according to a scheduling method, and miming the activity in a descending order of the activity priority.

According to the embodiment 1, a size of the user weight factor dynamic value can be represented by an integer or a decimal, which is a relative value. In a real system, it is usually represented by an integer, such as from 1 to 10 or 1 to 100, for easy understanding by administrators.

If the user chooses not to set an urgent activity, namely the user weight factor is not used, the user weight factor dynamic value is 1 by default, and has no weighting effect on the algorithm.

When there are too many user terminals requesting urgent activities, which is larger than the user weight factor quantity value set by the administrator terminal, the priority will be determined according to basic scheduling principles such as first-come-first-served.

The user weight factor cooling time is determined according to features of the activities, usually between 0 hours and 72 hours.

Working Principle:

According to the present invention, on the basis of conventional scheduling algorithm, the user weight factor dynamic value is added to the activity scheduling. The conventional scheduling algorithm only has static user weight which is determined according to a user level. The present invention also adds the user weight factor quantity value and the user weight factor cooling time, which not only prioritizes important and urgent activities, but also improves fairness of activity scheduling.

For example, there are three users U1, U2, and U3. If there are only static weights in the system, and U1 is a high-priority user, the activities of U2 and U3 may be delayed. However, to meet the needs of U2 and U3, higher priority can be given to only a small amount of their activities. In view of this situation, the present invention designs the user weight factor, wherein the user weight factor dynamic values are given to the U2 and U3. A larger user weight factor dynamic value provides a greater probability to execute the activity first.

However, in order to ensure the reasonable allocation of resources and avoid resource shortage, the user weight factor quantity values given to U2 and U3 will also be limited, for example, to 1. As a result, U2 and U3 can run 1 high-priority activity respectively. In this way, the high priority of U1 is not affected, while U2 and U3 can also execute activities as soon as possible. After the activity ends, U2 and U3 can submit high-priority activities again after the user weight factor cooling time, which increases the running frequency, in such a manner that the scheduling system can control the resource ratio and usage time.

In terms of the resource allocation of U2 and U3, if U2 needs to run activities frequently for a short period of time, a relatively short cooling time can be set, so that U2 has a high probability of allocating less time to run activities that are short or occupy fewer resources. If U3 needs to run activities for a long time, a longer cooling time can be set to prevent frequent submissions and long-term resource occupation.

It can be seen that for different users, setting different user weight factor dynamic values, different user weight factor quantity values and different user weight factor cooling times can enable related activities to run preferentially, in such a manner that user activities with different needs are all run preferentially to a certain extent.

In the step 103 comprises steps of:

201: determining whether an activity set M is empty, if not, going to a step 202; otherwise, skipping to a step 206;

202: calculating a weighted response ratio of each activity in the activity set M;

wherein the weighted response ratio=[(waiting time+estimated running time)/estimated running time]*user weight factor dynamic value=[1+(waiting time/estimated running time)]*user weight factor dynamic value;

203: according to a result of the step 202, finding out an activity mi with a highest weighted response ratio and a corresponding machine hj thereof;

204: sending the activity mi to the machine hj for running, and deleting the activity mi from the activity set M;

205: marking the machine hj as occupied; and

206: updating statuses of all other activities; receiving a new activity and putting the new activity into the activity set M, and returning to the step 201;

wherein the activity set M is a set of all unscheduled activities.

In the step 202, if the user terminal chooses not to use the user weight factor, the weighted response ratio is regarded as not considering the user weight factor dynamic value, which means the response ratio is no longer weighted, and activity priority does not change.

If the user terminal uses the user weight factor, the user weight factor dynamic value will be added to the response ratio formula to generate the weighted response ratio. All the activities are prioritized based on a range size of the weighted response ratios.

Here, “receiving a new activity and putting the new activity into the activity set M” refers to a scheduling cycle of the entire scheduling system. After each scheduling, the activity set M will intake new activities to be run for the next scheduling cycle. The service does not stop, so the scheduling keeps cycling, and the activity scheduling will be performed round by round.

In the step 204, if the user weight factor dynamic value of the activity mi is not 1, when the activity mi is deleted from the activity set M, the user weight factor quantity value of the user terminal corresponding to the activity is synchronously decreased by 1.

When the user weight factor dynamic value of the is not 1, that means the user terminal uses the user weight factor for activity settings. When the activity mi gets the highest weighted response ratio and is deleted from the activity set M after execution, the user weight factor quantity value will be synchronously reduced by 1 to prevent other activities from preempting resources.

After the user weight factor dynamic value of the user terminal is reduced by 1, when the user weight factor cooling time of the activity mi expires in the step 206, the user weight factor dynamic value of the activity mi is returned to the user terminal, and the user weight factor quantity value of the user terminal is increased by 1.

In the step 204, after the user weight factor quantity value is reduced by 1, it will be released after a cooling time due to the setting of the user weight factor cooling time. That is to say, in the step 206, the user weight factor quantity value is increased by 1 to be used by other activities, thereby orderly allocating the resources.

Furthermore, according to the embodiment 1, in the step 202, the weighted response ratio=[1+(waiting resource/estimated resource)]*user weight factor dynamic value.

The activity scheduling algorithm based on the high response ratio varies according to the system and the actual situation. For example, the users U1, U2, and U3 can be replaced by three kinds of software activities, wherein related parameters are also switched from estimated running time to estimated resources, and corresponding weighted response ratio is calculated.

### Embodiment 2

Furthermore, according to the embodiment 2, in the step 102, the system automatically assigns the user weight factor for the activities of the user terminal, and then submits the activity;

wherein:

when the user weight factor of the user terminal is larger than 0, the activity adopts the user weight factor dynamic value set in the step 101, and is not 1;

when the user weight factor of the user terminal is 0, the user weight factor dynamic value of the activity is 1 by default.

When the user terminal does not want to manually select whether the activities are urgent or not one by one, the system can automatically assign and use the user weight factor for the activities.

When the user weight factor is larger than 0, the system will automatically assign the user weight factor dynamic value to the user activity, and then calculate the weighted response ratio for the algorithm.

When the user weight factor is 0, namely the user weight factor of the user terminal has been exhausted, the user weight factor dynamic value of the activity is set to 1 by default and does not participate in the calculation of the weighted response ratio of the priority. No weighted effect is applied on the algorithm.

### Embodiment 3

An activity scheduling method based on a priority, comprising applying the user weight factor, wherein a weighted priority=fp;

wherein fp is a new weighted priority obtained by calculating a priority in a current algorithm with the user weight factor dynamic value.

In other scheduling algorithms, the user weight factor of the present invention can also be applied. In addition to the above formula, other adoptable formulas are:

Weighted priority=current algorithm priority*user dynamic weight factor;

Weighted priority=current algorithm priority+user dynamic weight factor.

All these formulas can help optimize the scheduling algorithm and improve the operation efficiency.

In summary, the present invention provides an activity scheduling method, system, terminal and storage medium based on a high response ratio.

What is claimed is:

1. An activity scheduling method based on a high response ratio, comprising steps of:
101: setting basic software and hardware information, an activity queue, a user authority, and a user weight factor through an administrator terminal;
wherein the user weight factor comprises: a user weight factor dynamic value, a user weight factor quantity value, and a user weight factor cooling time;
102: manually choosing whether to adopt the user weight factor for an activity through a user terminal, and then submitting the activity;
wherein:
choosing Yes, the activity adopts the user weight factor dynamic value set in the step 101, and is not 1; or
choosing No, the user weight factor dynamic value of the activity is 1 by default; and
103: entering an activity queuing stage of the user terminal, determining an activity priority of the user terminal according to a scheduling method, and running the activity in a descending order of the activity priority;
wherein the scheduling method in the step 103 comprises steps of:
201: determining whether an activity set M is empty, if not, going to a step 202; otherwise, skipping to a step 206;
202: calculating a weighted response ratio of each activity in the activity set M;
wherein the weighted response ratio=[(waiting time+estimated running time)/estimated running time]*user weight factor dynamic value=[1+(waiting time/estimated running time)]*user weight factor dynamic value;
203: according to a result of the step 202, finding out an activity mi with a highest weighted response ratio and a corresponding machine hj thereof;
204: sending the activity mi to the machine hj for running, and deleting the activity mi from the activity set M;
205: marking the machine hj as occupied; and
206: updating statuses of all other activities; receiving a new activity and putting the new activity into the activity set M, and returning to the step 201;
wherein the activity set M is a set of all unscheduled activities;
wherein in the step 204, if the user weight factor dynamic value of the activity mi is not 1, when the activity mi is deleted from the activity set M, the user weight factor quantity value of the user terminal corresponding to the activity is synchronously decreased by 1;
wherein after the user weight factor dynamic value of the user terminal is reduced by 1, when the user weight factor cooling time of the activity mi expires in the step 206, the user weight factor dynamic value of the activity mi is returned to the user terminal, and the user weight factor quantity value of the user terminal is increased by 1.

2. The activity scheduling method, as recited in claim 1, wherein in the step 202, the weighted response ratio=[1+(waiting resource/estimated resource)]*user weight factor dynamic value.

3. The activity scheduling method, as recited in claim 1, wherein in the step 102, the system automatically assigns the user weight factor for the activities of the user terminal, and then submits the activity;
wherein:
when the user weight factor of the user terminal is larger than 0, the activity adopts the user weight factor dynamic value set in the step 101, and is not 1;
when the user weight factor of the user terminal is 0, the user weight factor dynamic value of the activity is 1 by default.

4. An information data processing terminal to implement the activity scheduling method based on the high response ratio as recited in claim 1.

5. A computer-readable storage medium having instructions stored thereon, wherein when the instructions are executed on a computer, the computer executes the steps of the activity scheduling method based on the high response ratio as recited in claim 1.

6. A computer device, comprising a memory and a processor, wherein a computer program is stored in the memory, and the processor executes the computer program to execute the steps of the activity scheduling method based on the high response ratio as recited in claim 1.

7. An activity scheduling method based on a priority, comprising applying the user weight factor as recited in claim 1, wherein a weighted priority=fp;
wherein fp is a new weighted priority obtained by calculating a priority in a current algorithm with the user weight factor dynamic value.
